(19) United States
(12) Patent Application Publication
(10) Pub. No.: US 2025/0273954 A1
(43) Pub. Date: Aug. 28, 2025

(54) ELECTRONIC APPARATUS, IMAGE READING APPARATUS, AND RECORDING APPARATUS

(71) Applicant: SEIKO EPSON CORPORATION, Tokyo (JP)

(72) Inventor: Seiji TAKAMATSU, KITAKYUSHU-SHI (JP)

(21) Appl. No.: 19/062,822

(22) Filed: Feb. 25, 2025

(30) Foreign Application Priority Data
Feb. 28, 2024 (JP) 2024-028053

(51) Int. Cl. H02J 1/00; B41J 3/44; B41J 29/387; B41J 29/393; H04N 1/00; H04N 1/32

(52) U.S. Cl. CPC H02J 1/00; B41J 3/44; B41J 29/387; B41J 29/393; H04N 1/00822; H04N 1/00891; H04N 1/00901; H04N 1/32598; H04N 2201/0094

(57) ABSTRACT

An electronic apparatus includes a power switch element configured to switch on and off power supply, a power-source supply controller configured to request an external apparatus for the power supply when coupling with the external apparatus is established, and a power switch configured to switch on and off the power switch element. The power-source supply controller includes an output unit configured to switch from a first state to a second state when the coupling with the external apparatus is established. The electronic apparatus includes a power controlling switch element between the power switch element and the output unit, the power controlling switch element being configured to keep the power switch element off by remaining off until the power switch is operated when the output unit is in the second state and the power switch element is off.

The present application is based on, and claims priority from JP Application Serial Number 2024-028053, filed Feb. 28, 2024, the disclosure of which is hereby incorporated by reference herein in its entirety.

### BACKGROUND

### 1. Technical Field

The present disclosure relates to an electronic apparatus, an image reading apparatus, and a recording apparatus that operate with the power supplied from an external apparatus.

### 2. Related Art

As an electronic apparatus, a power reception apparatus that operates with the power supplied from an external apparatus when coupled with the external apparatus via an USB (Universal Serial Bus) interface is known. Such a power reception apparatus includes a PD (power-source supply) controller that controls the connection with the external apparatus. The PD controller performs a negotiation process for establishing connection with the external apparatus via the USB interface, and starts power reception when it is determined that power can be supplied.

For reference, JP-A-2009-15752 discloses a storage apparatus that operates with the power supplied from the external apparatus via the USB interface.

When the PD controller determines that power can be supplied, and the power reception is automatically started, and as such the power is consumed even when the power source of the power reception apparatus is off.

### SUMMARY

An electronic apparatus of the present disclosure is configured to operate with power supplied to an input power-source line from an external apparatus coupled to the electronic apparatus, the electronic apparatus including a power switch element configured to switch on and off power supply from the input power-source line to an output power-source line, a power-source supply controller configured to request the external apparatus supply power to the input power-source line when coupling with the external apparatus is established, a power switch configured to switch on and off the power switch element through operation, and a control unit configured to operate with power supplied to the output power-source line. The power-source supply controller includes an output unit configured to switch from a first state to a second state when the coupling with the external apparatus is established, and the electronic apparatus includes a power controlling switch element between the power switch element and the output unit, the power controlling switch element being configured to keep the power switch element off by remaining off until the power switch is operated when the output unit is in the second state and the power switch element is off.

An image reading apparatus of the present disclosure is configured to operate with power supplied to an input power-source line from an external apparatus coupled to the electronic apparatus, the image reading apparatus including a power switch element configured to switch on and off power supply from the input power-source line to an output power-source line, a power-source supply controller configured to request the external apparatus supply power to the input power-source line when coupling with the external apparatus is established, a power switch configured to switch on and off the power switch element through operation, a control unit configured to operate with power supplied to the output power-source line, and a reading unit configured to read a medium with the power supplied to the output power-source line. The power-source supply controller includes an output unit configured to switch from a first state to a second state when the coupling with the external apparatus is established, and the image reading apparatus includes a power controlling switch element between the power switch element and the output unit, the power controlling switch element being configured to keep the power switch element off by remaining off until the power switch is operated when the output unit is in the second state and the power switch element is off.

A recording apparatus of the present disclosure is configured to operate with power supplied to an input power-source line from an external apparatus coupled to the electronic apparatus, the recording apparatus including a power switch element configured to switch on and off power supply from the input power-source line to an output power-source line, a power-source supply controller configured to request the external apparatus supply power to the input power-source line when coupling with the external apparatus is established, a power switch configured to switch on and off the power switch element through operation, a control unit configured to operate with power supplied to the output power-source line, and a reading unit configured to read a medium with the power supplied to the output power-source line. The power-source supply controller includes an output unit configured to switch from a first state to a second state when the coupling with the external apparatus is established, and the recording apparatus includes a power controlling switch element between the power switch element and the output unit, the power controlling switch element being configured to keep the power switch element off by remaining off until the power switch is operated when the output unit is in the second state and the power switch element is off.

### BRIEF DESCRIPTION OF THE DRAWINGS

FIG. 1 is a block diagram schematically illustrating a configuration example of an electronic apparatus.

FIG. 2 is a circuit diagram schematically illustrating an example of a main part of the electronic apparatus.

FIG. 3 is a timing diagram schematically illustrating an operation of the electronic apparatus under normal conditions.

FIG. 4 is a timing diagram schematically illustrating an operation of the electronic apparatus when an overvoltage occurs.

FIG. 5 is a circuit diagram schematically illustrating another example of a main part of the electronic apparatus.

### DESCRIPTION OF EMBODIMENTS

An embodiment of the present disclosure is described below. Naturally, the following embodiment is merely illustrative of the present disclosure, and not all of the characteristics presented in the embodiment are essential to the solution of the disclosure.

### (1) Overview of Aspects Included in Present Disclosure

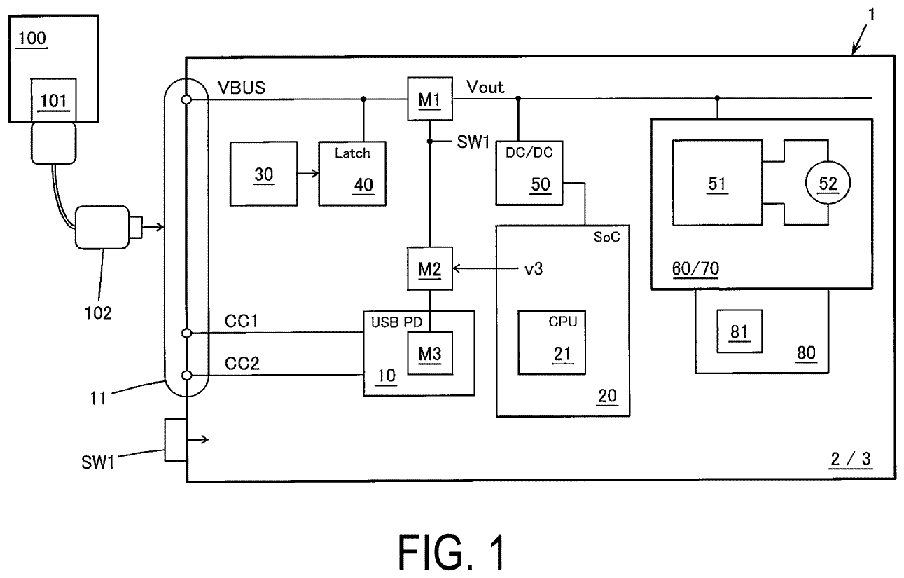

First, an overview of aspects included in the present disclosure is described with reference to the examples illustrated in FIGS. 1 to 5. Note that, the drawings in this application are schematic examples, and the magnification in each direction shown in these drawings may vary, and the drawings may not be consistent. Naturally, each element of this aspect is not limited to the specific examples indicated by the reference symbols. In “Overview of Aspects Included in Present Disclosure”, parentheses refer to supplementary explanations of the immediately preceding words.

### First Aspect

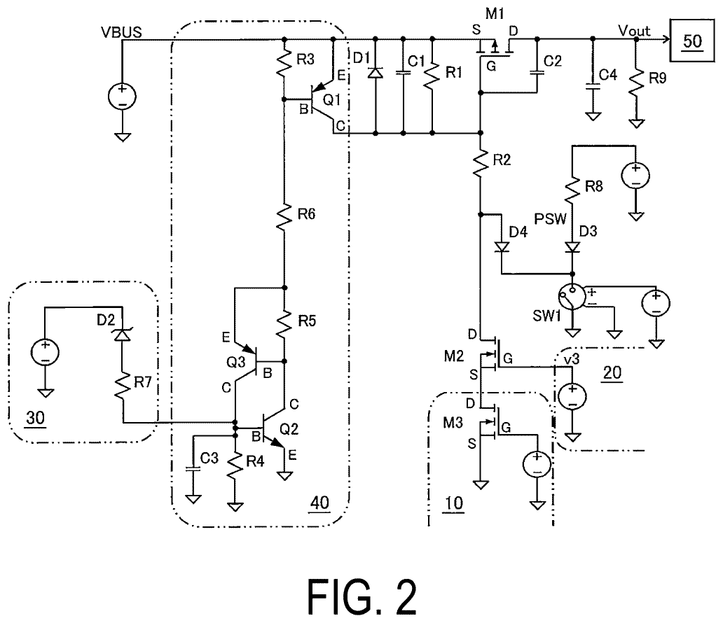

As exemplified in FIGS. 1 and 2 and the like, an electronic apparatus 1 according to an aspect operates with the power supplied to the input power-source line (e.g., VBUS) from an external apparatus 100 coupled to it. The electronic apparatus 1 includes a power switch element M1, a power-source supply controller (e.g., a USB PD controller 10), a power switch (e.g., a power-source tact switch SW1), a control unit 20, and a power controlling switch element M2. The power switch element M1 can switch the on and off the power supply from the input power-source line (VBUS) to the output power-source line (Vout). When the coupling with the external apparatus 100 is established, the power-source supply controller (10) requests the external apparatus 100 supply power to the input power-source line (VBUS). The power switch (SW1) can switch the on and off the power switch element M1 through operation. The control unit 20 operates with the power supplied to the output power-source line (Vout). Here, the power-source supply controller (10) includes an output unit M3 that is switched from a first state (e.g., off) to a second state (e.g., on) when the coupling with the external apparatus 100 is established. The power controlling switch element M2 is disposed between the power switch element M1 and the output unit M3, and keeps the power switch element M1 off by remaining off until the power switch (SW1) is operated when the output unit M3 is in the second state (on) and the power switch element M1 is off.

Thus, the power is not supplied to the power-receiving side until an operation of turning on the power source is performed. In this manner, this aspect can provide an electronic apparatus capable of reducing the power consumption, and contribute to energy conservation in the electronic apparatus.

This aspect may include various examples.

The power switch element M1 may be a FET (field effect transistor), a PNP-type transistor or the like.

The power controlling switch element M2 may be a FET, an NPN-type transistor or the like.

The output unit M3 of the power-source supply controller (10) may be a FET, an NPN-type transistor or the like.

The “first”, “second”, . . . in the subject application are used to identify each component in a plurality of components with similarities and do not mean order.

Naturally, the above-described notes also apply to the following aspects.

### Second Aspect

As exemplified in FIG. 2 and the like, the electronic apparatus 1 may further include a diode D4, the anode of which is coupled between the power switch element M1 and the power controlling switch element M2. The power switch (SW1) is disposed between the cathode of the diode D4 and the ground. When the power switch (SW1) is operated in the case where the output unit M3 is in the second state (on) and the power switch element M1 is on, the power controlling switch element M2 may be switched from on to off so as to turn off the power switch element M1.

In this case, when an operation of turning off the power source is performed, the power is not supplied to the power-receiving side. In this manner, this aspect can reduce the power consumption when the electronic apparatus is not used, and contribute to energy conservation in the electronic apparatus.

Note that, the coupling between the first element and the second element means that they are coupled such that DC current flows from one of these elements to the other. Accordingly, the coupling between the first element and the second element includes not only direct coupling between the first element and the second element, but also coupling between the first element and the second element through a resistor and the like. This note also applies to the following aspects.

### Third Aspect

Incidentally, when an abnormal condition occurs in the electronic apparatus on the power-receiving side and power reception needs to be stopped, correct signals may not be sent to the external apparatus due to the abnormal condition of the electronic apparatus on the power-receiving side and consequently the power reception may not be stopped. In view of this, as exemplified in FIGS. 1 and 2 and the like, the electronic apparatus 1 may further include an overvoltage detection unit 30 that detects an overvoltage applied to the electronic apparatus 1. In addition, the electronic apparatus 1 may further include a latch circuit 40 that switches off the power switch element M1 and keeps the power switch element M1 off when an overvoltage is detected.

In this case, the power switch (SW1) does not operate unless the user removes the electronic apparatus 1 from the external apparatus 100, and thus no power is supplied to the power-receiving side when an overvoltage occurs. In this manner, this aspect can protect the electronic apparatus from the overvoltage.

### Fourth Aspect

As exemplified FIG. 1, the electronic apparatus 1 may further include a motor 52. In addition, the electronic apparatus 1 may further include a motor driver 51 that can drive the motor 52 with the power supplied to the output power-source line (Vout). The control unit 20 may control the operation of the motor driver 51.

The motor 52 and the motor driver 51 require a lot of power. In this manner, this aspect can provide a preferable example for reducing power consumption.

### Fifth Aspect

As exemplified FIG. 2, the power switch element M1 may be a field effect transistor. The source of the power switch element M1 may be coupled to the input power-source line (VBUS). The drain of the power switch element M1 may be coupled to the output power-source line (Vout). The gate of the power switch element M1 may be coupled to the power controlling switch element M2 through a resistor R2.

This aspect can provide a suitable example for reducing the power consumption of the electronic apparatus.

### Sixth Aspect

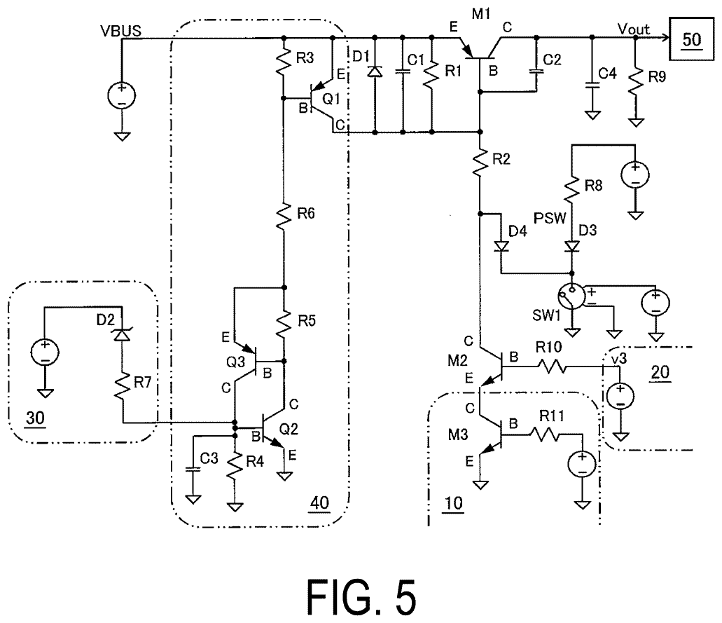

As exemplified FIG. 5, the power switch element M1 may be a PNP-type transistor. The emitter of the power switch element M1 may be coupled to the input power-source line (VBUS). The collector of the power switch element M1 may be coupled to the output power-source line (Vout). The base of the power switch element M1 may be coupled to the power controlling switch element M2 through the resistor R2.

This aspect can also provide a suitable example for reducing the power consumption of the electronic apparatus.

### Seventh Aspect

As exemplified FIG. 2, the power controlling switch element M2 may be a field effect transistor. The source of the power controlling switch element M2 may be coupled to the output unit M3. The drain of the power controlling switch element M2 may be coupled to the power switch element M1 through the resistor R2. A voltage signal v3 may be input to the gate of the power controlling switch element M2 from the control unit 20.

This aspect can also provide a suitable example for reducing the power consumption of the electronic apparatus.

### Eighth Aspect

As exemplified FIG. 5, the power controlling switch element M2 may be an NPN-type transistor. The emitter of the power controlling switch element M2 may be coupled to the output unit M3. The collector of the power controlling switch element M2 may be coupled to the power switch element M1 through the resistor R2. The voltage signal v3 may be input to the base of the power controlling switch element M2 from the control unit 20.

This aspect can also provide a suitable example for reducing the power consumption of the electronic apparatus.

### Ninth Aspect

An image reading apparatus 2 according to an aspect operates with the power supplied to the input power-source line (VBUS) from the external apparatus 100 coupled to it. The image reading apparatus 2 includes the power switch element M1, the power-source supply controller (10), the power switch (SW1), the control unit 20, and a reading unit 60. The reading unit 60 can read a medium 80 with the power supplied to the output power-source line (Vout).

Thus, the power is not supplied to the power-receiving side such as the reading unit 60 and the like until an operation of turning on the power source is performed. In this manner, this aspect can provide an image reading apparatus capable of reducing the power consumption, and contribute to energy conservation in the image reading apparatus.

### Tenth Aspect

A recording apparatus 3 according to an aspect operates with the power supplied to the input power-source line (VBUS) from the external apparatus 100 coupled to it. The recording apparatus 3 includes the power switch element M1, the power-source supply controller (10), the power switch (SW1), the control unit 20, and a recording unit 70. The recording unit 70 can record an image 81 on the medium 80 with the power supplied to the output power-source line (Vout).

Thus, the power is not supplied to the power-receiving side such as the recording unit 70 and the like until an operation of turning on the power source is performed. In this manner, this aspect can provide a recording apparatus capable of reducing the power consumption, and contribute to energy conservation in the recording apparatus.

### (2) Specific Examples of Electronic Apparatus

FIG. 1 is a block diagram schematically illustrating a configuration example of the electronic apparatus 1. FIG. 2 is a circuit diagram schematically illustrating an example of a main part of the electronic apparatus 1.

The electronic apparatus 1 illustrated in FIG. 1 is a power reception apparatus that operates with the power supplied from the external apparatus 100 coupled to it to the input power-source line VBUS. The electronic apparatus 1 may be the image reading apparatus 2, the recording apparatus 3, a digital camera, or the like. FIG. 1 collectively illustrates a case where the electronic apparatus 1 is the image reading apparatus 2, and a case where the electronic apparatus 1 is the recording apparatus 3. The image reading apparatus 2 serving as the electronic apparatus 1 includes the reading unit 60 that can read the medium 80 with the power supplied to the output power-source line Vout. The reading unit 60 includes a line sensor (not illustrated in the drawing) for reading the image 81 on the medium 80, the motor 52 that changes the relative positional relationship of the line sensor and the medium 80, the motor driver 51 that can drive the motor 52 with the power supplied to the output power-source line Vout, and the like. The recording apparatus 3 serving as the electronic apparatus 1 includes the recording unit 70 that can record the image 81 on the medium 80 with the power supplied to the output power-source line Vout. The recording unit 70 includes a recording head (not illustrated in the drawing) that forms the image 81 on the medium 80, the motor 52 that changes the relative positional relationship of the recording head and the medium 80, the motor driver 51 that can drive the motor 52 with the power supplied to the output power-source line Vout, and the like. The recording apparatus 3 may be an ink-jet printer, a thermal transfer printer or the like. Note that, the image 81 also includes letters group and the like.

As long as power can be supplied to the electronic apparatus 1, the external apparatus 100 may be an AC (Alternating Current) adapter, a computer such as a personal computer, a mobile battery, or the like. This specific example assumes that the electronic apparatus 1 operates in accordance with the USB (Universal Serial Bus) Type-C standard and the USB PD (power-source supply) standard. As such, the electronic apparatus 1 includes a receptacle 11 in accordance with the USB Type-C standard and the USB PD controller 10 that operates in accordance with the USB PD standard. The USB PD controller 10 is an example of the power-source supply controller, and requests the external apparatus 100 supply power to the input power-source line VBUS when the coupling with the external apparatus 100 is established. When receiving the above-described request, the external apparatus 100 starts the power supply to the input power-source line VBUS. The USB PD controller 10 includes the output unit M3 that switches from off to on when the coupling with the external apparatus 100 is established. The off of the output unit M3 serving as a switch element means a current interruption state, and the on of the output unit M3 serving as a switch element means a conduction state. The state where the output unit M3 is off is an example of the first state, and the state where the output unit M3 is on is an example of the second state. The on of the output unit M3 indicates that the coupling with the external apparatus 100 is established. The external apparatus 100 includes a USB interface 101 that operates in accordance with the Type-C standard and the USB PD standard. A USB cable including a plug 102 in accordance with the Type-C standard is coupled with the USB interface 101. The plug 102 and the receptacle 11 can fit with each other.

The power from the external apparatus 100 is supplied from the receptacle 11 to the input power-source line VBUS. The USB interface 101 and the USB PD controller 10 perform communication in accordance with the USB PD standard through a CC1 line and a CC 2 line. Note that, CC is an abbreviation for configuration channel. Although not shown in the drawing, the receptacle 11 also includes a GND terminal coupled to the ground of the electronic apparatus 1, and the like.

The electronic apparatus 1 illustrated in FIGS. 1 and 2 includes, in addition to the above-described USB PD controller 10 and the like, switch elements (M1, M2), the power-source tact switch SW1, the control unit 20, the overvoltage detection unit 30, the latch circuit 40, a DC/DC converter 50, and the like. Note that, DC is an abbreviation for direct current. The DC/DC converter 50 converts the direct current of the output power-source line Vout into the direct current of the operation voltage of the control unit 20 and the like. The DC/DC converter 50 may output a multi-stage DC voltage. The control unit 20 operates with the power supplied from the DC/DC converter 50. As such, it can be said that the control unit 20 operates with the power supplied to the output power-source line Vout through the DC/DC converter 50. The control unit 20 may be composed of a SoC (System on a Chip) including a CPU (Central Processing Unit) 21 serving as a processor, for example. The motor driver 51 illustrated in FIG. 1 directly receives the supply of power from the output power-source line Vout. The motor driver 51 may receive the supply of power from the DC/DC converter 50. The motor 52 may directly receive the supply of power from the output power-source line Vout. The control unit 20 controls the operation of the motor driver 51.

The electric circuit of the electronic apparatus 1 illustrated in FIG. 2 includes switch elements (M1 to M3), transistors Q1 to Q3, diodes (D1 to D4), resistors R1 to R9, capacitors C1 to C4, and the like. The off of the switch elements (M1 to M3) and the transistors Q1 to Q3 means a current interruption state, and the on of the switch elements (M1 to M3) and the transistors Q1 to Q3 means a conduction state.

The switch elements (M1 to M3) illustrated in FIG. 2 are FETs (Field Effect Transistors), or more specifically MOSFETs (Metal Oxide Semiconductor Field Effect Transistors). For convenience, the source is indicated by “S”, the drain is indicated by “D”, and the gate is indicated by “G”. “G” may be denoted by “G₁”.

The power switch element M1 illustrated in FIG. 2 is a P-channel MOSFET. The source of the power switch element M1 is coupled to the input power-source line VBUS. The drain of the power switch element M1 is coupled to the output power-source line Vout. The gate of the power switch element M1 is coupled to the drain of the power controlling switch element M2 through the resistor R2. The power switch element M1 can switch the on and off the power supply from the input power-source line VBUS to the output power-source line Vout.

The output unit M3 illustrated in FIG. 2 is an N-channel MOSFET included in the USB PD controller 10. The source of the output unit M3 is coupled to the ground. The drain of the output unit M3 is coupled to the source of the power controlling switch element M2.

The power-source tact switch SW1 can switch the on and off the power switch element M1 through operation. The tact switch is equipped with a momentary operation actuator that is energized when pushed, and de-energized when released. The user can turn on the power source of the electronic apparatus 1 by pushing the power-source tact switch SW1 when the power source of the electronic apparatus 1 is off. In addition, the user can turn off the power source of the electronic apparatus 1 by pushing the power-source tact switch SW1 when the power source of the electronic apparatus 1 is on.

The power controlling switch element M2 illustrated in FIG. 2 is an N-channel MOSFET located between the power switch element M1 and the output unit M3. The source of the power controlling switch element M2 is coupled to the drain of the output unit M3. The drain of the power controlling switch element M2 is coupled to the gate of the power switch element M1 through the resistor R2. As such, it can be said that the switch elements (M1 to M3) are indirectly coupled in series. The gate of the power controlling switch element M2 is coupled to the control unit 20. The voltage signal v3 is input to the gate of the power controlling switch element M2 from the control unit 20. The power controlling switch element M2 keeps the power switch element M1 off by remaining off until the power-source tact switch SW1 is operated when the output unit M3 is on and the power switch element M1 is off.

The diode D4 is disposed between the power controlling switch element M2 and the power-source tact switch SW1. The anode of the diode D4 is coupled between the resistor R2 and the power controlling switch element M2. As such, it can be said that the anode of the diode D4 is coupled between the power switch element M1 and the power controlling switch element M2. The power-source tact switch SW1 is disposed between the cathode of the diode D4 and the ground. The power controlling switch element M2 turns off the power switch element M1 when the power-source tact switch SW1 is operated and switched from on to off in the case where the output unit M3 is on and the power switch element M1 is on.

The overvoltage detection unit 30 includes the resistor R7 and a Zener diode D2. One end of the resistor R7 is coupled to the anode of the Zener diode D2, and the other end of the resistor R7 is coupled to the ground through the resistor R4. The output of the DC/DC converter 50 is input to the cathode of the Zener diode D2, for example. The cathode of the Zener diode D2 may be coupled to the output power-source line Vout. The Zener voltage of the Zener diode D2 is set to be higher than the voltage of normal conditions. When a voltage greater than the Zener voltage is applied to the Zener diode D2, a breakdown current flows through the Zener diode D2. As such, it can be said that a voltage greater than the Zener voltage is an overvoltage applied to the electronic apparatus 1. The overvoltage detection unit 30 detects an overvoltage applied to the electronic apparatus 1.

The latch circuit 40 includes the transistors Q1 to Q3, the resistors R3 to R6, and the capacitor C3. For convenience of description, in the transistors Q1 to Q3, the emitter is indicated by “E”, the collector by “C”, and the base by “B”.

The transistor Q1 is a PNP-type transistor. The emitter of the transistor Q1 is coupled to the input power-source line VBUS. The collector of the transistor Q1 is coupled between the power switch element M1 and the resistor R2. The base of the transistor Q1 is coupled between the resistor R3 and the resistor R6.

The transistor Q2 is an NPN-type transistor. The emitter of the transistor Q2 is coupled to the ground. The collector of the transistor Q2 is coupled between the base of the transistor Q3 and the resistor R5. The base of the transistor Q2 is coupled between the resistor R7 and the resistor R4.

The transistor Q3 is an NPN-type transistor. The emitter of the transistor Q3 is coupled between the resistor R6 and the resistor R5. The collector of the transistor Q3 is coupled between the resistor R7 and the base of the transistor Q2. The base of the transistor Q3 is coupled between the resistor R5 and the collector of the transistor Q2.

When a current due to overvoltage flows from the Zener diode D2 to the ground through the resistors R7 and R4, a current flows through the base of the transistor Q2, which turns on the transistor Q2, thus pulling down the voltage at the collector of the transistor Q2. As a result, a current flows from the base of the transistor Q3 to turn on the transistor Q3, and thus the transistor Q3 conducts a current from the emitter to the collector. In this state, the transistors Q2 and Q3 remain on. The emitter of the transistor Q3 pulls a current from the resistor R6, and thus the transistor Q1 turns on. As a result, the power switch element M1 switches from on to off. Thereafter, the transistors Q1 to Q3 remain on, and thus the power switch element M1 is kept off. In this manner, when an overvoltage is detected, the latch circuit 40 switches the power switch element M1 off, and keeps the power switch element M1 off. Since the latch circuit 40 is independent of the control unit 20, the power reception reliably stops in the case of overvoltage.

With the start of the power supply from the output power-source line Vout as a trigger, the control unit 20 outputs to the gate of the power controlling switch element M2 the voltage signal v3 that turns on the power controlling switch element M2. In addition, the control unit 20 can read a potential state PSW of the anode of the diode D3. When detecting an operation of the power-source tact switch SW1 by reading a switch of the potential state PSW from H to L, the control unit 20 performs a process of turning off the power source using a CPU 21, and outputs to the gate of the power controlling switch element M2 the voltage signal v3 that turns off the power controlling switch element M2.

### (3) Operations of Electronic Apparatus According to Specific Examples

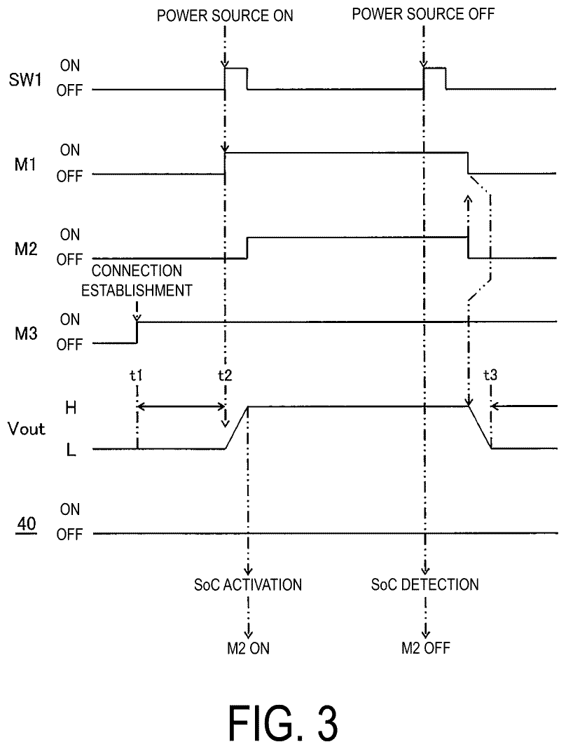

FIG. 3 is a timing diagram schematically illustrating an operation of the electronic apparatus 1 under normal conditions. Under normal conditions, the latch circuit 40 is kept off.

When the plug 102 is inserted to the receptacle 11 and the like and the electronic apparatus 1 and the external apparatus 100 are coupled to each other, the USB PD controller 10 performs negotiation communication in accordance with the USB PD standard with the USB interface 101. When a connection with the external apparatus 100 is established, the USB PD controller 10 requests the external apparatus 100 supply power to the input power-source line VBUS, and switches the output unit M3 from off to on (timing t1). When receiving the above-described request, the external apparatus 100 starts the power supply to the input power-source line VBUS. In this case, if the power-source tact switch SW1 is not operated, the gate of the voltage signal v3 that turns on the power controlling switch element M2 is not input, and thus the power controlling switch element M2 remains off. In addition, since the voltage that turns on the gate of the power switch element M1 is not input, the power switch element M1 remains off. In this manner, the power controlling switch element M2 keeps the power switch element M1 off by remaining off until the power-source tact switch SW1 is operated when the output unit M3 is on and the power switch element M1 is off. The operation of the power-source tact switch SW1 that is performed in this state is an operation of turning on the power source of the electronic apparatus 1.

When the power-source tact switch SW1 is operated into momentary ON, a voltage for turning on through the resistor R2 and the diode D4 is input to the gate of the power switch element M1, and the power switch element M1 is switched from off to on (timing t2). When the power switch element M1 turns on, power is supplied from the input power-source line VBUS to the output power-source line Vout, and the voltage of the output power-source line Vout rises from L (low) to H (high). This activates the DC/DC converter 50, and in turn activates the control unit 20 (e.g., SoC), thus outputting to the gate of the power controlling switch element M2 the voltage signal v3 that turns on the power controlling switch element M2. As a result, the power controlling switch element M2 is switched from off to on. When the power controlling switch element M2 is on, the power switch element M1 is kept on even when the user releases the power-source tact switch SW1.

As illustrated in FIG. 3, in the period from timing t1 to timing t2, the output power-source line Vout does not rise, and no power is supplied to the control unit 20, the motor driver 51 or the like. In this manner, even when the coupling between the electronic apparatus 1 and the external apparatus 100 is established, the power is not supplied to the power-receiving side until the power-source tact switch SW1 is operated. In this manner, the power consumption in the period from timing t1 to timing t2 is reduced.

The operation of the power-source tact switch SW1 that is performed after the power controlling switch element M2 turns on is an operation of turning off the power source of the electronic apparatus 1. When the power-source tact switch SW1 is operated into momentary ON, the control unit 20 performs an operation of turning off the power source using the CPU 21 by detecting the operation of the power-source tact switch SW1 by reading the dropping of the potential state PSW of the anode of the diode D3 from H to L. At this time, the control unit 20 outputs to the gate of the power controlling switch element M2 the voltage signal v3 that turns off the power controlling switch element M2. When the power controlling switch element M2 is switched from on to off, a voltage that turns off the power switch element M1 is input to the gate of the power switch element M1, and the power switch element M1 switches from on to off. In this manner, the output power-source line Vout drops from H to L, and the same state as in the period from timing t1 to timing t2 is set (timing t3). In this manner, the power controlling switch element M2 turns off the power switch element M1 when the power-source tact switch SW1 is operated and switched from on to off in the case where the output unit M3 is on and the power switch element M1 is on.

As illustrated in FIG. 3, after timing t3, the output power-source line Vout is kept L, and thus no power is supplied to the control unit 20, the motor driver 51 or the like. In this manner, when an operation of turning off the power source is performed, the power is not supplied to the power-receiving side. Thus, the power consumption until an operation of turning on the power source is performed is reduced.

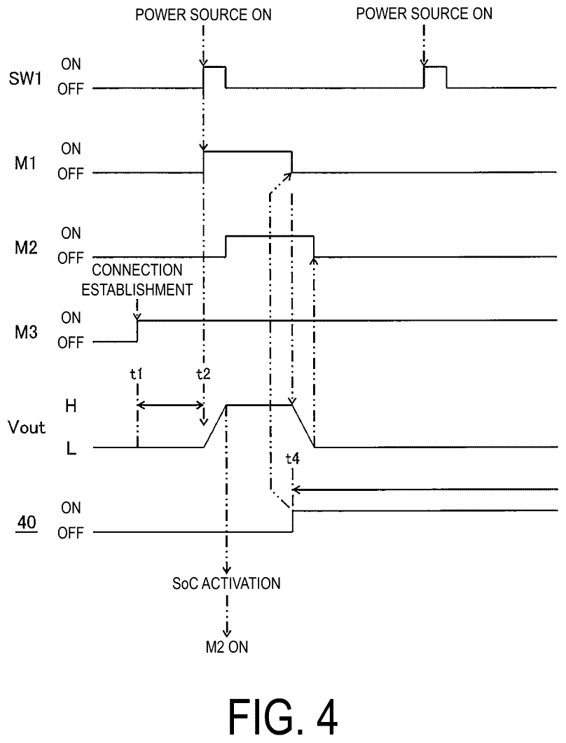

FIG. 4 is a timing diagram schematically illustrating an operation of the electronic apparatus 1 when an overvoltage occurs.

Until the power controlling switch element M2 is switched from off to on, the operation is performed as illustrated in FIG. 3. When an overvoltage occurs, a current flows from the Zener diode D2 to the ground through the resistors R7 and R4, and a current flows through the base of the transistor Q2, thus switching the transistor Q2 from off to on. When the transistor Q2 turns on, the transistor Q3 switches from off to on, and the transistors Q2 and Q3 remain on. When the transistor Q3 turns on, the transistor Q1 switches from off to on. In this manner, the latch circuit 40 switches from off to on when an overvoltage is detected. When the transistor Q1 turns on, the power switch element M1 switches from on to off (timing t4), the output power-source line Vout drops from H to L. Since the transistors Q2 and Q3 remain on, the power switch element M1 is kept off even when the power-source tact switch SW1 is operated unless the user removes the electronic apparatus 1 from the external apparatus 100. In other words, the power-source tact switch SW1 does not function. In this manner, when an overvoltage is detected, the latch circuit 40 switches off the power switch element M1, and keeps the power switch element M1 off. In this manner, no power is supplied to the power-receiving side when an overvoltage occurs, and thus the electronic apparatus is protected from the overvoltage.

As described above, even when the connection between the electronic apparatus 1 and the external apparatus 100 is established, the power is not supplied to the power-receiving side until the power-source tact switch SW1 is operated, and when an operation of turning off the power source is performed, the power is not supplied to the power-receiving side. In this manner, this specific example can reduce the power consumption of the electronic apparatus 1, contribute to energy conservation of the electronic apparatus 1, and protect the electronic apparatus 1 from overvoltage.

### (4) Modifications

Various modifications may be made for the present disclosure.

For example, at least some of the switch elements (M1 to M3) may be replaced by transistors other than FETs.

FIG. 5 is a circuit diagram schematically illustrating another example of a main part of the electronic apparatus 1. The circuit illustrated in FIG. 5 differs from the circuit illustrated in FIG. 2 in that the switch elements (M1 to M3) are replaced by transistors other than FETs, and resistors R10 and R11 are additionally provided.

As illustrated in FIG. 5, the power switch element M1 may be a PNP-type transistor. The emitter of the power switch element M1 illustrated in FIG. 5 is coupled to the input power-source line VBUS. The collector of the power switch element M1 illustrated in FIG. 5 is coupled to the output power-source line Vout. The base of the power switch element M1 illustrated in FIG. 5 is coupled to the collector of the power controlling switch element M2 through the resistor R2.

Thus, the power switch element M1 can switch the on and off the power supply from the input power-source line VBUS to the output power-source line Vout.

As illustrated in FIG. 5, the output unit M3 may be an NPN-type transistor. The emitter of the output unit M3 illustrated in FIG. 5 is coupled to the ground. The collector of the output unit M3 illustrated in FIG. 5 is coupled to the emitter of the power controlling switch element M2.

As illustrated in FIG. 5, the power controlling switch element M2 may be an NPN-type transistor. The emitter of the power controlling switch element M2 illustrated in FIG. 5 is coupled to the collector of the output unit M3. The collector of the power controlling switch element M2 illustrated in FIG. 5 is coupled to the base of the power switch element M1 through the resistor R2. The base of the power controlling switch element M2 illustrated in FIG. 5 is coupled to the control unit 20 through the resistor R10. The voltage signal v3 is input to the base of the power controlling switch element M2 from the control unit 20. The power controlling switch element M2 keeps the power switch element M1 off by remaining off until the power-source tact switch SW1 is operated when the output unit M3 is on and the power switch element M1 is off. The power controlling switch element M2 turns off the power switch element M1 when the power-source tact switch SW1 is operated and switched from on to off in the case where the output unit M3 is on and the power switch element M1 is on.

The electronic apparatus 1 including the circuit illustrated in FIG. 5 also operates as illustrated in FIGS. 3 and 4. Thus, the electronic apparatus 1 whose switch elements (M1 to M3) are replaced by transistors other than FETs can reduce the power consumption of the electronic apparatus 1, contribute to energy conservation of the electronic apparatus 1, and protect the electronic apparatus 1 from overvoltage.

Note that, even with a transistor in which some of the switch elements (M1 to M3) are FETs and remaining elements are not FETs, the electronic apparatus 1 operates as illustrated in FIGS. 3 and 4.

### (5) Conclusion

As explained above, according to the present disclosure, it is possible to provide a configuration of an electronic apparatus and the like that can reduce power consumption in various ways. Naturally, the basic actions and effects described above can be obtained even when the configuration consists only of the configuration requirements pertaining to the independent claims.

It is also possible to implement configurations in which each of the configurations disclosed in the above examples is mutually substituted or combined, configurations in which each of the configurations disclosed in the known technology and in the above examples is mutually substituted or combined, and so on. The present disclosure also includes these configurations and the like.

What is claimed is:

1. An electronic apparatus configured to operate with power supplied to an input power-source line from an external apparatus coupled to the electronic apparatus, the electronic apparatus comprising:
a power switch element configured to switch on and off power supply from the input power-source line to an output power-source line;
a power-source supply controller configured to request the external apparatus supply power to the input power-source line when coupling with the external apparatus is established;
a power switch configured to switch on and off the power switch element through operation; and
a control unit configured to operate with power supplied to the output power-source line, wherein
the power-source supply controller includes an output unit configured to switch from a first state to a second state when the coupling with the external apparatus is established, and
the electronic apparatus includes a power controlling switch element between the power switch element and the output unit, the power controlling switch element being configured to keep the power switch element off by remaining off until the power switch is operated when the output unit is in the second state and the power switch element is off.

2. The electronic apparatus according to claim 1, further comprising a diode an anode of which is coupled between the power switch element and the power controlling switch element, wherein
the power switch is disposed between a cathode of the diode and a ground, and
the power controlling switch element turns off the power switch element by switching from on to off when the power switch is operated when the output unit is in the second state and the power switch element is on.

3. The electronic apparatus according to claim 1, further comprising:
an overvoltage detection unit configured to detect an overvoltage applied to the electronic apparatus; and
a latch circuit configured to switch the power switch element off and keep the power switch element off when the overvoltage is detected.

4. The electronic apparatus according to claim 1, further comprising:
a motor; and
a motor driver configured to drive the motor with the power supplied to the output power-source line, wherein
the control unit controls an operation of the motor driver.

5. The electronic apparatus according to claim 1, wherein
the power switch element is a field effect transistor,
a source of the power switch element is coupled to the input power-source line,
a drain of the power switch element is coupled to the output power-source line, and
a gate of the power switch element is coupled to the power controlling switch element through a resistor.

6. The electronic apparatus according to claim 1, wherein
the power switch element is a PNP-type transistor,
an emitter of the power switch element is coupled to the input power-source line,
a collector of the power switch element is coupled to the output power-source line, and
a base of the power switch element is coupled to the power controlling switch element through a resistor.

7. The electronic apparatus according to claim 1, wherein
the power controlling switch element is a field effect transistor,
a source of the power controlling switch element is coupled to the output unit,
a drain of the power controlling switch element is coupled to the power switch element through a resistor, and
a voltage signal from the control unit is input to a gate of the power controlling switch element.

8. The electronic apparatus according to claim 1, wherein
the power controlling switch element is an NPN-type transistor,
an emitter of the power controlling switch element is coupled to the output unit,
a collector of the power controlling switch element is coupled to the power switch element through a resistor, and
a voltage signal from the control unit is input to a base of the power controlling switch element.

9. An image reading apparatus configured to operate with power supplied to an input power-source line from an external apparatus coupled to the electronic apparatus, the image reading apparatus comprising:
a power switch element configured to switch on and off power supply from the input power-source line to an output power-source line;
a power-source supply controller configured to request the external apparatus supply power to the input power-source line when coupling with the external apparatus is established;
a power switch configured to switch on and off the power switch element through operation;
a control unit configured to operate with power supplied to the output power-source line; and
a reading unit configured to read a medium with the power supplied to the output power-source line, wherein
the power-source supply controller includes an output unit configured to switch from a first state to a second state when the coupling with the external apparatus is established, and
the image reading apparatus includes a power controlling switch element between the power switch element and the output unit, the power controlling switch element being configured to keep the power switch element off by remaining off until the power switch is operated when the output unit is in the second state and the power switch element is off.

10. A recording apparatus configured to operate with power supplied to an input power-source line from an external apparatus coupled to the electronic apparatus, the recording apparatus comprising:
a power switch element configured to switch on and off power supply from the input power-source line to an output power-source line;
a power-source supply controller configured to request the external apparatus supply power to the input power-source line when coupling with the external apparatus is established;
a power switch configured to switch on and off the power switch element through operation;
a control unit configured to operate with power supplied to the output power-source line; and
a reading unit configured to read a medium with the power supplied to the output power-source line, wherein
the power-source supply controller includes an output unit configured to switch from a first state to a second state when the coupling with the external apparatus is established, and
the recording apparatus includes a power controlling switch element between the power switch element and the output unit, the power controlling switch element being configured to keep the power switch element off by remaining off until the power switch is operated when the output unit is in the second state and the power switch element is off.
